(19) United States
(12) Patent Application Publication
(10) Pub. No.: US 2013/0087219 A1
(43) Pub. Date: Apr. 11, 2013

(54) METHOD OF HEATING GAS TURBINE INLET

(71) Applicants: Prabhakaran Saraswathi Rajesh, Trivandrum (IN); Rahul Jaikaran Chillar, Atlanta, GA (US); Bradly Aaron Kippel, Greenville, SC (US); Ricky Daryl Conard, Greer, SC (US)

(72) Inventors: Prabhakaran Saraswathi Rajesh, Trivandrum (IN); Rahul Jaikaran Chillar, Atlanta, GA (US); Bradly Aaron Kippel, Greenville, SC (US); Ricky Daryl Conard, Greer, SC (US)

(73) Assignee: General Electric Company, Schenectady, NY (US)

(21) Appl. No.: 13/253,214

(22) Filed: Oct. 5, 2011

(51) Int. Cl. F15D 1/00

(52) U.S. Cl. 137/338

(57) ABSTRACT

An air inlet system delivers a flow of air. The system included a temperature controlling section configured to alter temperature of the air flow. The temperature controlling section imparts a temperature variation distribution across different portions of the air flow. The system also includes a transition section, one or more flow diverters, one or more screens and/or a flow splitter to cause mixing of the different, temperature variant portions of the air flow and reduce the temperature variation distribution.

### BACKGROUND OF THE INVENTION

1. Field of the Invention

The invention relates to gas turbines and, more particularly, to an inlet system for a gas turbine that improves thermal mixing of air flowing from the inlet system and into the gas turbine.

2. Discussion of Prior Art

Inlet systems for gas turbines are generally used for treating air that passes to the gas turbine. The air can be treated by filtering, heating, cooling, or the like. Providing heated air to the gas turbine can improve plant efficiency, but can also create a thermal distortion at the inlet of the gas turbine. Heated air can exhibit a thermal distortion within the inlet system due to a lack of thermal mixing and mixing length within the inlet system. For instance, warmer air can accumulate towards the top of the inlet system while colder air can accumulate towards the bottom of the inlet system. This temperature difference can linger throughout the inlet system and to the outlet of the inlet system. However, to increase efficiency and structural life of a compressor in the gas turbine, the maximum thermal distortion (e.g., temperature difference between a maximum and minimum temperature) of air at an outlet of the inlet system should be no more than 10° Fahrenheit (“F”). Accordingly, it would be useful to provide a method and/or device to mix the air within the inlet system to produce air having a substantially uniform temperature distribution. Additionally, it would be useful to provide a method and/or device to solve the aforementioned problems without a major modification in the overall design of the inlet system.

### BRIEF DESCRIPTION OF THE INVENTION

The following summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

In accordance with one aspect the present invention provides an air inlet system for delivering a flow of air. The system included a temperature controlling section configured to alter temperature of the air flow. The temperature controlling section imparts a temperature variation distribution across different portions of the air flow. The system also includes a transition section positioned downstream from the temperature controlling section. The transition section has surfaces oriented at an angle that is neither parallel not perpendicular with respect to a flow direction of the air flow entering the transition section to cause mixing of the different, temperature variant portions of the air flow and reduce the temperature variation distribution.

In accordance with another aspect, the present invention provides an air inlet system for delivering a flow of air. The system includes a temperature controlling section configured to alter temperature of the air flow. The temperature controlling section imparts a temperature variation distribution across different portions of the air flow. The system includes at least one flow diverter positioned downstream from the temperature controlling section. The at least one flow diverter extends transverse with respect to a flow direction of the air flow moving past the at least one flow diverter to divert the air flow around the at least one flow diverter to cause mixing of the different, temperature variant portions of the air flow and reduce the temperature variation distribution.

In accordance with another aspect, the present invention provides an air inlet system for delivering a flow of air. The system includes a temperature controlling section configured to alter temperature of the air flow. The temperature controlling section imparts a temperature variation distribution across different portions of the air flow. The system includes at least one screen positioned downstream from the temperature controlling section. The at least one screen extending transverse with respect to a flow direction of the air flow moving past the at least one screen. At least a first portion of the air flow moves through the screen to cause turbulence and cause mixing of the different, temperature variant portions of the air flow and reduce the temperature variation distribution. The system also includes a flow diverter positioned downstream from the temperature controlling section and within the air flow to divert at least some of the air flow to a first side of the flow diverter and to divert at least some of the air flow to a second side of the flow diverter to cause turbulence and cause mixing of the different, temperature variant portions of the air flow and reduce the temperature variation distribution.

### BRIEF DESCRIPTION OF THE DRAWINGS

The foregoing and other aspects of the invention will become apparent to those skilled in the art to which the invention relates upon reading the following description with reference to the accompanying drawings, in which:

FIG. 1 is a schematized perspective view of an example inlet system for a gas turbine;

FIG. 2 is a schematized cross-section view of the example inlet system of FIG. 1 including an example transition section in accordance with an aspect of the present invention;

FIG. 3 is a schematized perspective view of the example inlet system including the transition section of FIG. 2;

FIG. 4a is a side view temperature distribution plot of the example inlet system without the transition section of FIGS. 2 and 3;

FIG. 4b is a temperature distribution plot at an outlet of the example inlet system without the transition section of FIGS. 2 and 3;

FIG. 4c is a side view temperature distribution plot of the example inlet system with the transition section of FIGS. 2 and 3;

FIG. 4d is a temperature distribution plot at the outlet of the example inlet system with the transition section of FIGS. 2 and 3;

FIG. 5 is a graph showing a relationship of temperature distribution in an example inlet system with and without the example transition section of FIGS. 2 and 3;

FIG. 6 is a schematized cross-section view of a second example inlet system including an example flow diverter in accordance with another aspect of the present invention; and

FIG. 7 is a schematized cross-section view of a third example inlet system including an example screen and an example flow splitter in accordance with another aspect of the present invention.

### DETAILED DESCRIPTION OF THE INVENTION

Example embodiments that incorporate one or more aspects of the invention are described and illustrated in the drawings. These illustrated examples are not intended to be a limitation on the invention. For example, one or more aspects of the invention can be utilized in other embodiments and even other types of devices. Moreover, certain terminology is used herein for convenience only and is not to be taken as a limitation on the invention. Still further, in the drawings, the same reference numerals are employed for designating the same elements.

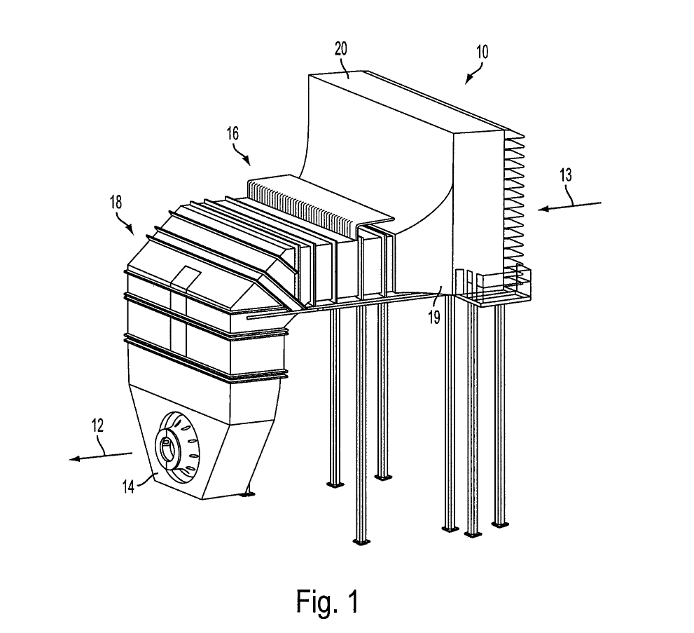

FIG. 1 illustrates an example inlet system 10 for delivering an exiting air flow 12 from an outlet 14 that can be utilized by a device (not shown), such as a gas turbine according to one aspect of the invention. Within the shown example, the outlet 14 has a general ring cross-sectional shape area through which the exiting air flow 12 proceeds. Of course, a different shape could be provided. An entering air flow 13 can be drawn from an exterior location and into the inlet system 10.

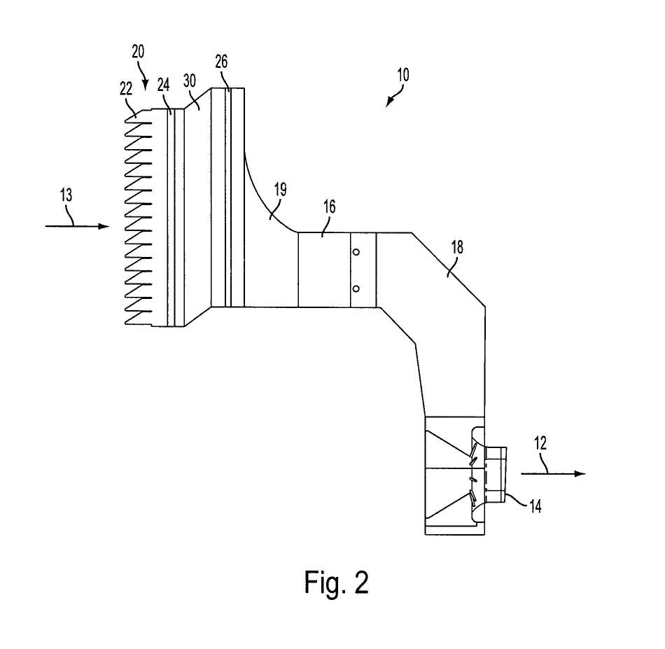

Turning to the portions of the inlet system 10 shown within the example of FIG. 1, the outlet 14 is in fluid communication with a duct section 18. The outlet 14 is positioned adjacent to, and downstream from, the duct section 18. The duct section 18 can define a passageway through which the air flow 13 can pass. The duct section 18 is shown to have a substantially 90° bend. However, it is to be understood that the duct section 18 can take on a number of different sizes, shapes, and configurations, and is not limited to the structure shown in the example of FIG. 2. For instance, the duct section 18 could be substantially straight, without a 90° bend. Similarly, the duct section 18 could include the one bend, or multiple bends. As such, the duct section 18 can take on a number of configurations without substantially altering the passage of the air flow 13 through the duct section 18.

The inlet system 10 includes an inlet section 20. It should be appreciated that the inlet section 20 is somewhat generically shown within FIG. 1. This generic representation is such to convey the concept that the inlet section 20 of the inlet system 10 shown in FIG. 1 can represent a prior art construction or a construction in accordance with one or more aspects of the present invention as will be described in follow passages.

The inlet section 20 includes one or more hoods 22. The hoods 22 can provide a shielding function to help protect the inlet system 10 from ingesting at least some materials and/or precipitation that may otherwise enter the inlet section 20. Examples of such materials that the hoods 22 can shield from ingestion can include, but are not limited to, leaves, branches, animals, dust, particulates, etc. The precipitation that the hoods 22 can limit entrance of can include, but is not limited to, water, rain, snow, hail, sleet, etc. In the shown example, a plurality of hoods is organized in a stacked configuration (e.g., each hood extending left to right, and the hoods located in a vertically extending sequence) across the inlet section 20. The hoods 22 extend outwardly from the inlet section 20. Of course, the hoods 22 are not limited to the shown example, and can take on a number of different sizes, shapes, and configurations. Moreover, the hoods 22 can be designed to withstand some amount of impact force from the materials and/or precipitation. For example, the hoods 22 can withstand heavy precipitation, such as a heavy rain, wind, or snow accumulation, without breaking while still reducing the amount of precipitation that enters the inlet section 20.

The example inlet system 10 includes a reduction section 19 positioned adjacent to, and downstream from, the inlet section 20. The reduction section 19 has an inlet portion that has a larger cross-sectional area and that is located adjacent to the inlet section 20, and outlet portion that has a smaller cross-sectional area and that is located distal from the inlet section 20. As such, the reduction section 19 is tapered, such that a cross-sectional area of an upstream portion of the reduction section 19 is larger than the cross-sectional area of a downstream portion. Air flow 13 enters the inlet portion of the reduction section 19, passes through the reduction section 19, and exits through the outlet portion of the reduction section 19.

The example inlet system 10 further includes a silencer section or simply a silencer 16. The silencer 16 is positioned adjacent to and/or downstream from the reduction section 19 and upstream of the duct section 18. The air flow 13 passes from the reduction section 19, through the silencer 16 and to the duct section 18. The silencer 16 can be disposed within the inlet system 10 and can dampen noise generated within the inlet system 10. Silencers are well known in the art, and can include a number of different structures that reduce and/or dampen noise. As such, the silencer 16 described herein could include a number of different silencers that function to reduce and/or dampen noise.

With the portions shown within FIG. 1 now identified, it should be appreciated that the inlet section 20, the reduction section 19, the silencer 16, the duct section 18, and the outlet section 14 are all sequentially in fluid communication with each other. It is to be understood that the inlet system 10 is of FIG. 1 is only generically/schematically shown, and is not intended to be a limitation upon the present invention. As such, the inlet system 10 is not limited to the structure of the shown example, and can be varied in a number of ways. For instance, the inlet system 10 could include further structures that are not shown in the example and/or could operate without some of the structures shown. In addition, the inlet system 10 could be used with a variety of different structures and is not limited to gas turbines. For instance, the inlet system 10 could be operatively associated with a compressor during part load operation, any type of combined cycle power plant, or the like.

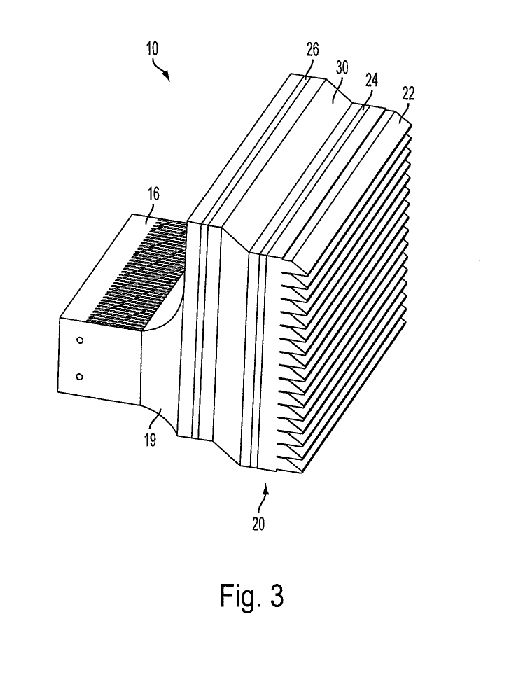

Referring now to FIGS. 2 and 3, further details of the example inlet system 10 of FIG. 1 in accordance with an aspect of the present invention are shown. Specifically, for the example shown within FIGS. 2 and 3 the inlet section 20 of the inlet system 10 includes several items. First, a temperature controlling section 24 is provided. The temperature controlling section 24 can be positioned downstream, adjacent/near, the hoods 22. The temperature controlling section 24 thus can receive the air flow 13 that initially passes into the inlet section 20. As such, the air flow 13 can pass from an exterior location, past the hoods 22, and to/through the temperature controlling section 24. The temperature controlling section 24 can change the temperature of the air flow 13 that passes through the temperature controlling section 24. As such, air flow 13 leaving the temperature controlling section 24 can have a different temperature than the air flow 13 entering the temperature controlling section 24.

In one example, the temperature controlling section 24 could heat the air flow 13 by increasing the temperature of the air. In such an example, the temperature controlling section 24 could include a variety of heating structures, including heater(s), heating coil(s), heat exchanger(s), or the like. It is to be understood that the temperature controlling section 24 is not limited to the examples described herein, and that a number of different heating structures can be provided that function to heat the air flow 13 through the temperature controlling section 24. The temperature controlling section 24 can heat the air flow 13 along a variety of temperature ranges. For instance, the temperature controlling section 24 can heat the air flow from 59° Fahrenheit (“F”) to 140° F. Similarly, the temperature controlling section 24 can heat a cold air flow from (−20° F. to 80° F. The temperature controlling section 24 is not limited to these heating ranges and, depending on the specific type of heating structure and/or power output, could heat the air flow 13 to a greater or smaller temperature range. The temperature controlling section 24 can heat some or all of the air flow 13 that flows through the temperature controlling section 24.

The temperature controlling section 24 is not limited to heating. In further examples, the temperature controlling section 24 could include a cooling structure that could cool the air flow 13 by decreasing the temperature of the air. In such an example, the temperature controlling section 24 could include a variety of cooling structures, including cooling coil(s), heat exchanger(s), or the like. It is to be understood that the temperature controlling section 24 is not limited to the examples described herein, and that a number of different cooling structures can be provided that are capable of cooling the air flow 13 through the temperature controlling section 24. The temperature controlling section 24 can cool the air flow 13 along a variety of temperature ranges depending on the specific type of cooling structure and/or power output. The temperature controlling section 24 can cool some or all of the air flow 13 that flows through the temperature controlling section 24. Thus, the temperature controlling section 24 is configured to alter temperature of the air flow 13.

It should be appreciated that as the air flow 13 exits the temperature controlling section 24, different portions of the air flow 13 may have different temperatures. For example, warm or hot air can accumulate towards an upper portion of the air flow 13. Similarly, cold or cooler air can accumulate towards a bottom portion of the air flow 13. As such, air flow 13 exiting the temperature controlling section 24 can be cooler towards the bottom and warmer towards the top. Thus, the temperature controlling section 24 imparts a temperature variation distribution across different portions of the air flow 13. It should be noted, air flow 13 having a temperature variation may cause undesired results. For example, it is possible that a temperature variation within the air flow 13 may reduce the structural life and efficiency of a gas turbine receiving the exiting air flow 12.

Referring still to FIGS. 2 and 3, the inlet section 20 of the inlet system 10 can further include a transition section 30 in accordance with an aspect of the invention. The transition section 30 can be positioned adjacent to and downstream from the temperature controlling section 24. The transition section 30 can receive the air flow 13 that passes from temperature controlling section 24. The transition section 30 can define a substantially hollow passageway for air flow 13.

In the shown example, the transition section 30 extends upwardly at an angle from the temperature controlling section 24. Specifically, the transition section 30 extends upwardly at an angle with respect to horizontal. The angle of the transition section 30 is shown to be about 30° with respect to horizontal, but the angle can be smaller or larger. For instance, the angle of the transition section 30 can range between an angle of 0° or close to 0°, and up to 60° and higher. A typical angle of the transition section 30 could be 37° to 45° degrees from horizontal depending on the availability of space. Moreover, it is to be understood that the transition section 30 is not limited to extending upwardly, and could also extend downwardly, sideways, and/or diagonally from the temperature controlling section 24. The transition section 30 could further include multiple angles, such as by extending upwardly then downwardly, or the like. Similarly, the transition section 30 can be longer or shorter in length, and is not limited to the dimensions of the shown example. In general, the transition section 30 has surfaces oriented at an angle that is neither parallel not perpendicular with respect to a flow direction of the air flow entering the transition section.

The transition section 30 can improve thermal distribution and mixing within the inlet system 10 by increasing the mixing of the air flow 13. The result is a more homogenous temperature within the air flow 13. For example, the transition section 30 can increase the length and change the direction that the air flow 13 travels through the inlet system 10. Specifically, the transition section 30 increases the distance that the air flow 13 must travel after passing through the temperature controlling section 24. As another example, the transition section 30 can also increase the turbulence of the air flow 13 due, in part, to the angle of the transition section 30 with respect to the temperature controlling section 24. For instance, in the shown examples of FIGS. 2 and 3, the bottom portion of the transition section 30 can direct the cold air upwards. The cold air can mix with the warmer air that is disposed towards the top of the transition section 30. Accordingly, the mixture of cold air and warm air within the transition section 30 can produce an air flow having a more uniform temperature distribution. Thus, the transition section 30 has surfaces oriented at an angle that is neither parallel not perpendicular with respect to a flow direction of the air flow entering the transition section to cause mixing of the different, temperature variant portions of the air flow and reduce the temperature variation distribution.

It should be noted that the inlet system 10 can be constructed anew with the transition section 30 part of the original construction. In the alternative if the inlet system 10 is pre-existing, the transition section 30 can be added to the inlet system 10 by removing the hoods 22, etc. and installing the transition section 30.

Referring still to FIGS. 2 and 3, the inlet system 10 can further include a filter 26. The filter 26 can be positioned adjacent to and downstream from the transition section 30. The filter 26 can receive the air flow 13 that passes through the transition section 30. As such, the air flow 13 can pass from an exterior location, through the temperature controlling section 24, through the transition section 30 and to the filter 26.

The filter 26 can be mounted to extend perpendicularly or substantially perpendicularly with respect to the air flow 13. As such, the filter 26 can extend substantially across the inlet system 10 such that some or all of the air flow 13 can pass through the filter 26. The filter 26 can include a variety of different types of filters that can remove particles from the air flow 13. For instance, the filter 26 could include a water tight filter that prevents and/or limits liquids and/or aqueous solutions within the air flow 13 from passing through the filter 26. Similarly, other filters are contemplated that could remove dry particles from the air flow 13, such as salt, dust, corrosives, water, etc. The filter 26 could include fiberglass, or another suitable filtering material, and may have a coating or treatment made from a hydrophobic material or some other suitable water tight coating or treatment material. The types of filters described herein are not intended to be a limitation upon the filter 26 of the present invention, and any number of filters could be used, depending on the specific application.

The overall operation of the example inlet system 10 shown in FIGS. 2 and 3 can now be reviewed. Air enters the inlet system 10 through the inlet section 20. The hoods 22 can at least partially reduce the amount of materials and/or precipitation that enters the inlet section 20. The temperature controlling section 24 can change the temperature of the air flow that passes through the temperature controlling section 24. Specifically, the temperature controlling section 24 can selectively heat or cool the air flow. Air exiting the temperature controlling section 24 encounters the transition section 30. The transition section 30 helps to mix the flow. For example, the transition section 30 direct cold air upwards, causing the cold air to mix with warmer air. As another example, the transition section 30 increases the distance that the heated/cooled air will travel between the temperature controlling section 24 and the filter 26. As such, the ability to mix cold air and warm air within the transition section 30 is increased, thus producing an air flow having a more uniform temperature distribution. The filter 26 remove particles and/or liquids from the air flow as the air flow passes through the filter 26. The air flow can then pass through the reduction section 19, silencer 16, and duct section 18. The exiting air flow 12 can exit the outlet 14 before entering the gas turbine. Of note, the exiting air flow 12 has improved temperature mixing to provide a minimized temperature gradient distribution.

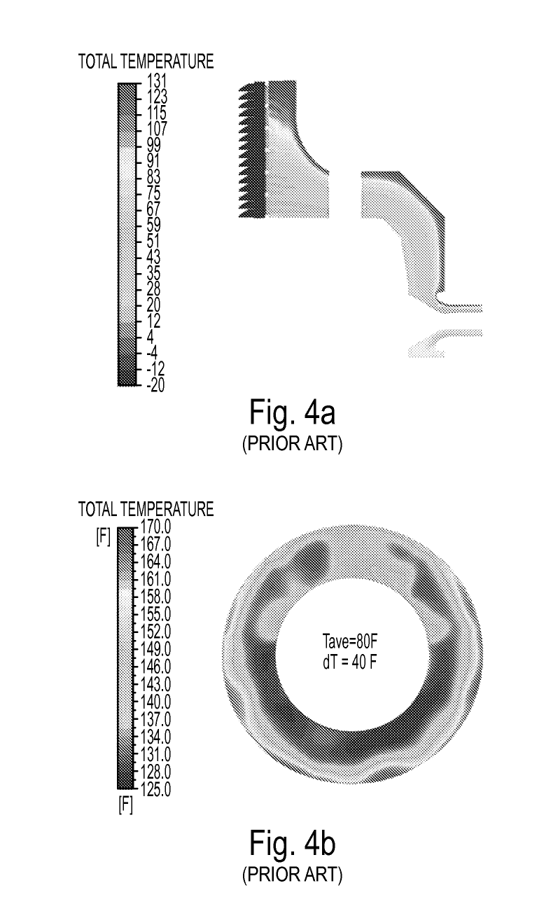

Referring now to the series of FIGS. 4a-4d, temperature distribution improvement to air flow within the inlet system 10 is indicated. With regard to FIGS. 4a and 4b, a temperature distribution map is shown for the inlet system 10 without a transition section 30. As such, it is possible to consider FIGS. 4a and 4b to represent the prior art before the improvement provided in accordance with the present invention. Referring first to FIG. 4a, a temperature distribution of a cross sectional view of an inlet system is shown. The temperature is represented in Fahrenheit (“F”). Warmer air (up to 131° F.) is disposed towards an upper portion of the inlet system near a top surface. Cooler air (down to 43° F.) is disposed towards a bottom portion of the inlet system near a bottom surface. Air at a middle temperature is disposed between the warmer and cooler air. As shown, the wanner and cooler air remains segregated throughout the entire inlet system, starting from behind the temperature controlling section (in this example, a heating section) and continuing to the outlet.

Referring now to FIG. 4b, a temperature distribution map is shown for the outlet 14 of the inlet system 10 without a transition section 30. Recall that the example outlet 14 is substantially ring-shaped. Warmer air and cooler air remain segregated at the outlet 14 of the inlet system. Cooler air is disposed towards a center portion (inner diameter) of the outlet while warmer air is disposed towards an outer portion (outer diameter) of the outlet. The temperature difference between the warmest air and coldest air at the outlet is approximately 40° F.

With regard to FIGS. 4c and 4d, temperature distribution maps are shown for the inlet system 10 that has a transition section 30 in accordance with an aspect of the present invention. Referring first to FIG. 4c, a temperature distribution map is shown for a cross sectional view of the inlet system 10 that includes the transition section 30. The temperature is again represented in Fahrenheit. The temperature distribution within the inlet system 10 is more mixed and homogenized than the example of FIG. 4a, thus leading to a more uniform temperature distribution. Warmer air is still somewhat disposed towards an upper portion of the inlet system 10; however the warmer air is in the temperature range of approximately 83° F., as opposed to 131° F. in the inlet system 10 without the transition section 30. Similarly, the cooler air is in the temperature range of approximately 80° F., as opposed to 43° F. in the inlet system 10 without the transition section 30.

Referring now to FIG. 4d, a temperature distribution map is shown for the outlet 14 of the inlet system 10 that has a transition section 30 in accordance with an aspect of the present invention. As with the temperature distribution map shown in FIG. 4c, the temperature distribution at the outlet 14 is more mixed and homogenized within the temperature distribution map of FIG. 4d than the example of FIG. 4b. As such, the outlet 14 exhibits a more uniform temperature distribution of warm and cool air. Warmer air is somewhat disposed towards an inner diameter and outer diameter of the outlet 14. Cooler air is disposed between the inner diameter and the outer diameter. The maximum temperature of the warmer air is approximately 85° F. while the minimum temperature of the cooler air is approximately 75° F. As such, the temperature difference between the warmest air and coldest air at the outlet 14 is approximately 10° F.

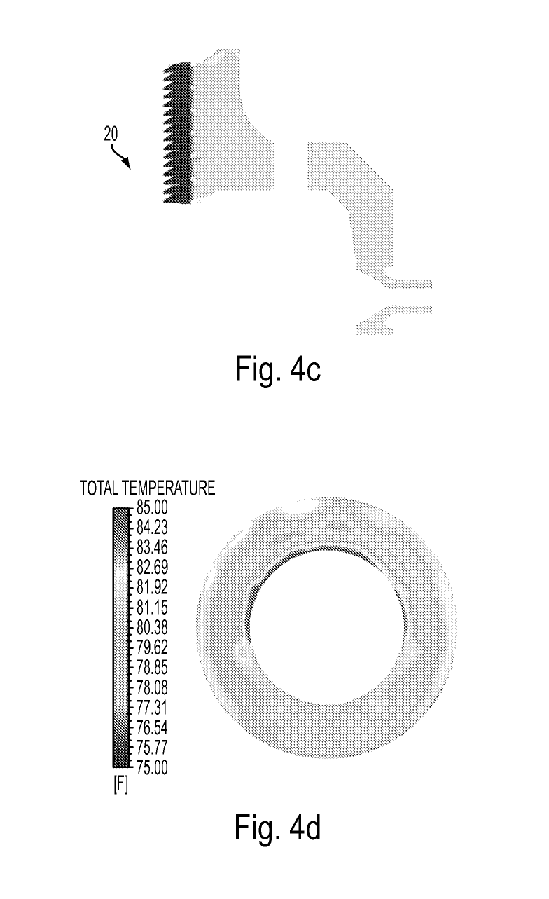

Referring now to the graph of FIG. 5, a relative temperature distortion comparison between the inlet system 10 with the transition section 30 and the inlet system 10 without the transition section 30 is provided. The y-axis represents the temperature distortion (in degrees Fahrenheit) indicates the temperature difference between maximum temperature and minimum temperature at a specific location within the inlet system 10. The x-axis represents specific locations at which the maximum and minimum temperature is measured. Inlet system location 1 correlates with temperature being measured at the silencer 16 (shown in FIG. 2). Inlet system location 2 correlates with temperature being measured at the duct section 18 (shown in FIG. 2). Inlet system location 3 correlates with temperature being measured at the outlet 14 (shown in FIG. 2).

The graph displays two separate temperature distortion curves. A first curve shown as a solid line represents the inlet system 10 without a transition section. A second curve shown as a dotted line represents the inlet system 10 with the transition section 30 shown within FIGS. 2 and 3. With regard to Inlet System Location 1 measured at the silencer 16, the inlet system without the transition section exhibits a temperature distortion of approximately 45° F. This temperature represents the temperature difference between the maximum and minimum temperature taken at the silencer. In contrast, the inlet system with the transition section exhibits a temperature distortion of approximately 12° F. With regard to Inlet System Location 2 measured at the duct section 18, the inlet system without the transition section exhibits a temperature distortion of approximately 45° F. In contrast, the inlet system with the transition section exhibits a temperature distortion of approximately 7° F. Lastly, with regard to Inlet System Location 3 measured at the outlet 14, the inlet system without the transition section exhibits a temperature distortion of approximately 45° F. In contrast, the inlet system with the transition section exhibits a temperature distortion of approximately 5° F. Accordingly, the inlet system 10 that includes the transition section 30 exhibits a smaller temperature distribution between the maximum and minimum temperatures as compared to an inlet system without the transition section.

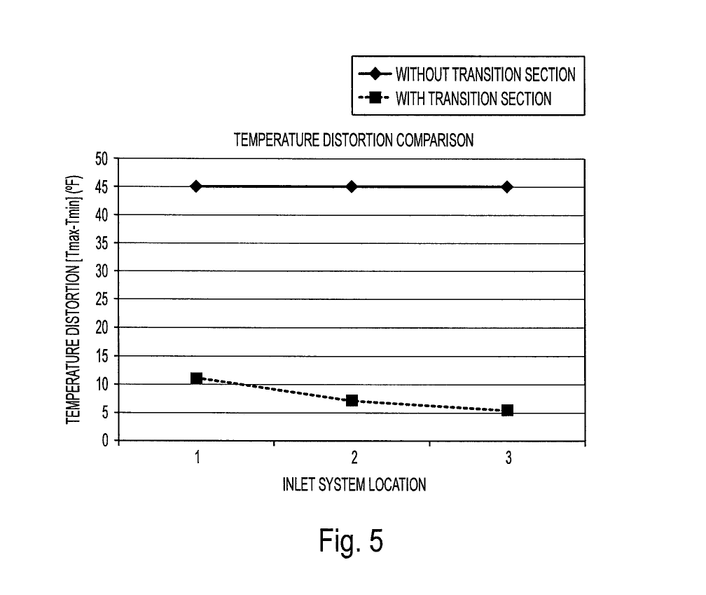

Referring now to FIG. 6, a second example of an inlet system 110 in accordance with another aspect of the present invention is shown. The inlet system 110 includes an inlet section 120. The inlet section 120 allows for the air flow similar to the previous example of FIGS. 2 and 3.

As with the previous example, the inlet section 120 includes one or more hoods 122. Also, similar to the previous example, the inlet system 110 includes a temperature controlling section 124. The temperature controlling section 124 can be the same/similar to the temperature controlling section 24 described above with respect to FIGS. 2 and 3. In short summary, the temperature controlling section 124 can change the temperature of the air flow that passes through the temperature controlling section 124.

The inlet system 110 (FIG. 6) includes a filter 126 that can be the same/similar to the filter 26 described above with respect to FIGS. 2 and 3. Also, the inlet system 110 includes a reduction section 119 that can be the same/similar to the reduction section 19 described above with respect to FIGS. 2 and 3. Also, the inlet system 110 includes a silencer 116 that can be the same/similar to the silencer 16 described above with respect to FIGS. 2 and 3.

Referring still to FIG. 6, the inlet system 110 includes a flow diverter 130 in accordance with an aspect of the present invention. The flow diverter 130 is positioned downstream from the temperature controlling section 124. The flow diverter 130 extends upwardly from a bottom surface of the inlet system 110 and extends laterally, partially or completely, across the inlet system 110. Thus, the flow diverter 130 extends transverse with respect to a flow direction of the air flow moving past the flow diverter 130. The flow diverter 130 can include a variety of different structures. For instance, the flow diverter 130 can include a strip of material, such as metal, plastic, etc., that extends laterally along the bottom of the inlet system 110. In a further example, the flow diverter 130 could include a bottom surface of the inlet system 110 that extends upwardly to form the flow diverter 130, such that the flow diverter 130 is integrally formed with the bottom surface.

The flow diverter 130 could include a single flow diverter, or multiple flow diverters that, in combination, function similarly to a single flow diverter. For instance, multiple flow diverters could be positioned in series along the bottom surface of the inlet system 10. Similarly, the flow diverters could each have the same height, or could have varying heights. Further still, each of plural flow diverters can each extend across the bottom surface a varying length. For example, one flow diverter could extend completely across the bottom surface while another flow diverter could extend only partially across the bottom surface. Even further, each flow diverter could have a differing shape as compared to another flow diverter. For example, differences in inclination or differences in tapers (e.g., a taller section tapering off into a shorter section) are possible. It is to be understood, however, that the flow diverter 130 can take on any number of sizes, shapes, structures, configurations, etc. and is not limited to the examples shown and described herein.

The flow diverter 130 is not limited to the location shown in FIG. 6, and can be positioned at a variety of locations throughout the inlet system 110. For instance, the flow diverter 130 could be positioned downstream from the position shown in flow diverter 130. Further, the flow diverter 130 could be positioned within the reduction section 119, within the silencer 116, within the duct section (not shown in FIG. 6), or the like. In fact, multiple flow diverters, if present, could be positioned at varying locations within the inlet system 110. In further examples, the flow diverter could be positioned on side walls as well.

The flow diverter 130 can improve thermal distortion within the inlet system 110 by increasing the mixing of the air flow. As stated above, air flow passing through the inlet system 110 can include pockets of warmer air and pockets of colder air. The colder air can sometimes accumulate towards a bottom portion of the inlet system 110 downstream from the temperature controlling section 124. As the air flow passes through the inlet system 110, the flow diverter 130 can direct the colder air upwards towards a center of the inlet system 110. The colder air will be diverted over the flow diverter 130 as it passes through the inlet system 110. As the colder air is diverted upwards, the colder air can mix with warmer air from the air flow, thus reducing the temperature difference between the maximum and minimum temperature of air within the air flow. Thus, the flow diverter 130 extends transverse with respect to the flow direction of the air flow moving past the flow diverter to divert the air flow around the flow diverter to cause mixing of the different, temperature variant portions of the air flow and reduce the temperature variation distribution.

The inlet system 110 can further include a second flow diverter 132. The second flow diverter 132 can be positioned at a variety of locations within the inlet system 110, including, but not limited to, at an upwardly located portion of the reduction section 119 or within a silencer 116. The second flow diverter 132 can extend laterally, partially or completely, across the inlet system 110 and can project downwardly from a top surface of the inlet system 110. The second flow diverter 132 can include a variety of different structures. For instance, the second flow diverter 132 can include a strip of material, such as metal, that extends across the inlet system 110. In a further example, the second flow diverter 132 could include a top surface of the inlet system 110 that projects downwardly to form the second flow diverter 132.

As with the flow diverter 130, the second flow diverter 132 could include a single second flow diverter, or multiple second flow diverters that, in combination, function similarly to the second flow diverter 132. For instance, multiple second flow diverters could be positioned in series along the top surface of the inlet system 110. Similarly, the second flow diverters could each have the same height, or could have varying heights. Further still, the second flow diverters can each extend across the top surface a varying length, such as with one second flow diverter extending completely across the top surface while another second flow diverter extends only partially across the top surface. Even further, each second flow diverter could have a varying shape, such as being inclined, or having a taller section tapering off into a shorter section. It is to be understood, however, that the second flow diverter 132 can take on any number of sizes, shapes, structures, configurations, etc. and is not limited to the examples shown and described herein.

The second flow diverter 132 is not limited to the location shown in FIG. 6, and can be positioned at a variety of locations throughout the inlet system 110. For instance, the second flow diverter 132 can be positioned differently (e.g., downstream) from the position shown with FIG. 6. The second flow diverter 132 could be positioned within the reduction section 119, the silencer 116, the duct section (not shown), or the like. In fact, multiple second flow diverters could be positioned at varying locations within the inlet system 110. In further examples, the flow diverter could be positioned on side walls as well.

The second flow diverter 132 can improve the thermal distortion within the inlet system 110 by increasing the mixing of the air flow. As stated above, air flow passing through the inlet system 110 can include pockets of warmer air and pockets of colder air. The warmer air can sometimes accumulate towards an upper portion of the inlet system 110. As the air flow passes through the inlet system 110, the second flow diverter 132 can direct the warmer air downwards toward a center of the inlet system 110. The warmer air will be diverted under the second flow diverter 132 as it passes through the inlet system 110. As the warmer air is diverted downwards, the warmer air can mix with the colder air, thus reducing the temperature difference between the maximum and minimum temperature of air within the air flow.

It is to be understood that the flow diverter 130 and second flow diverter 132 are not limited to the example shown in FIG. 6. For instance, in a further example, the flow diverter 130 and/or the second flow diverter 132 could be included in the example shown in FIGS. 2 and 3. As such, the flow diverter 130 and/or the second flow diverter 132 can be combined with an inlet system having a transition section 30. In such an example, the flow diverter 130 and/or the second flow diverter 132 could include any number of flow diverters, and could be positioned at a variety of locations within the inlet system, such as within the transition section 30, reduction section, silencer, duct section, etc. As such, the example shown and described with respect to FIG. 6 can include some or all of the features from the example shown and described with respect to FIGS. 2 and 3.

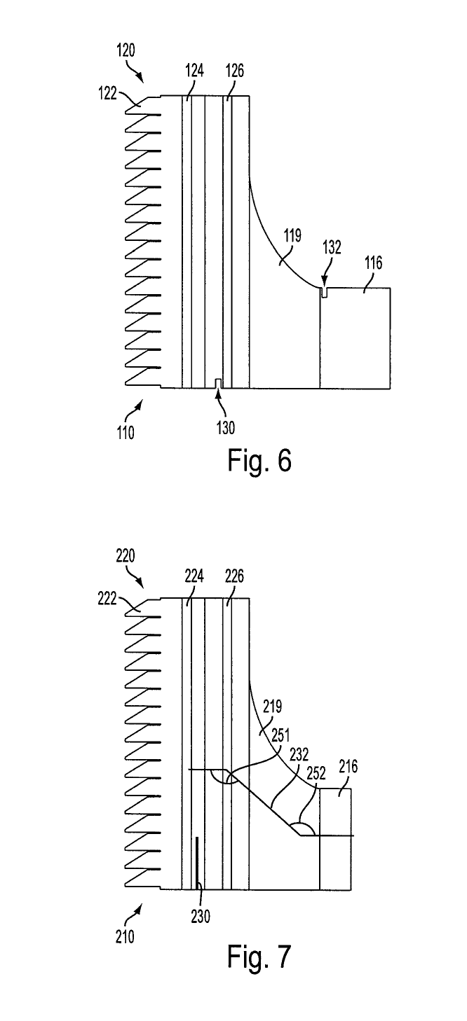

Referring now to FIG. 7, a third example of an inlet system 210 in accordance with another aspect of the present invention is shown. The inlet system 210 includes an inlet section 220. The inlet section 220 can define one or more passageways for the air flow to enter the inlet system 210. The inlet section 220 allows for the air flow similar to the previous examples.

As with the previous examples, the inlet section 220 includes one or more hoods 222. Also, similar to the previous examples, the inlet system 210 include a temperature controlling section 224. The temperature controlling section 224 can be the same/similar to the temperature controlling section 224 described above. In short summary, the temperature controlling section 124 can change the temperature of the air flow that passes through the temperature controlling section 124.

The inlet system 110 includes a filter 226 that can be the same/similar to the filter 26 described above with respect to FIGS. 2 and 3. Also, the inlet system 110 includes a reduction section 219 that can be the same/similar to the reduction section 19 described above with respect to FIGS. 2 and 3. Also, the inlet system 110 includes a silencer 216 that can be the same/similar to the silencer 16 described above with respect to FIGS. 2 and 3.

Referring still to FIG. 7, the inlet system 210 includes a screen 230. The screen 230 can be positioned downstream from the temperature controlling section 224. The screen 230 can extend partially or completely across the inlet system 210 and can extend upwardly from a bottom surface of the inlet system 210. Thus, the screen 230 extends transverse with respect to the flow direction of the air flow moving past the screen. The screen 230 can include a variety of different structures. For instance, the screen 230 can include a mesh structure that allows air flow to pass partially through the screen 230. For instance, the screen 230 could include a metal wire, fiberglass, or other synthetic fiber mesh. In one example, the screen 230 can allow 80% of the air flow that encounters the screen 230 to pass through the screen 230. However, it is to be understood that more or less air can pass through the screen 230. Air that does not pass through the screen 230 can be diverted upwardly towards a center of the inlet system 210. As such, a portion of the air flow can pass through the screen 230 while another portion of the air flow can be diverted upwards to flow over the screen 230.

The screen 230 could include a single screen, or multiple screens that, in combination, function similarly to the screen 230. For instance, multiple screens could be positioned in series along one of the surfaces of the inlet system 210. Similarly, the screen(s) could each have the same height, or could have varying heights. Further still, the screen(s) can each extend across a surface of the inlet system 210 a varying length, such as with one screen extending completely across the surface while another screen extends only partially across the surface. Even further, each screen could have a varying shape, such as being inclined, or having a taller section tapering off into a shorter section. The screen 230 is also not limited to being positioned on the bottom surface of the inlet system 210. In a further example, one or more screens can be positioned on any or all of the bottom surface, side surfaces, or top surface of the inlet system 210. Similarly, the screen 230 is not limited to being positioned between the temperature controlling section 224 and filter 226. In a further example, the screen 230 could be positioned nearly anywhere within the inlet system, including, but not limited to, the reduction section 219, silencer 216, duct section (not shown), etc. It is to be understood, that the screen 230 can take on any number of sizes, shapes, structures, configurations, etc. and is not limited to the examples shown and described herein.

The screen 230 can improve thermal distortion within the inlet system 210 by increasing the mixing of the air flow. As stated above, air flow passing through the inlet system 210 can include pockets of warmer air and pockets of colder air. The colder air can accumulate towards a bottom portion of the inlet system 210. As the air flow passes through the inlet system 210, a portion of the air flow can pass through the screen 230 while another portion of the air flow can be diverted upwards to flow over (or around) the screen 230. As the colder air is diverted upwards, the colder air can mix with warmer air, thus reducing the temperature difference between the maximum and minimum temperature of air within the air flow. In a further example, the screen 230 could be positioned at the top surface of the inlet system 210, such that warm air is diverted both through the screen 230, and under the screen 230 to mix with the colder air. Thus, at least a first portion of the air flow moves through the screen to cause turbulence and cause mixing of the different, temperature variant portions of the air flow and reduce the temperature variation distribution.

The inlet system 210 also includes a third example flow diverter. The third example flow diverter can include a flow splitter 232. The flow splitter 232 can be positioned at a variety of locations within the inlet system 210. In the shown example, the flow splitter 232 can extend from the temperature controlling section 224 to the silencer 216. It is to be understood, however, that the flow splitter 232 could be positioned entirely within the reduction section 219, entirely within a silencer 216, or at other locations. Similarly, the flow splitter 232 could include more than one flow splitter 232. In such an example, one flow splitter could be positioned at a first location within the inlet system 210 while a second flow splitter could be positioned at a separate location. For instance, a first flow splitter could extend from the temperature controlling section 224 to the filter 226 while a second flow splitter could extend from the reduction section 219 to the silencer 216. This example is not intended to be a limitation, and the flow splitter 232 could include multiple flow splitters positioned at a variety of locations throughout the inlet system 210.

The flow splitter 232 can extend partially or completely across the inlet system 210. As such, the flow splitter 232 can separate the inlet system 210 into two regions, an upper region, located above the flow splitter 232, and a lower region, located below the flow splitter 232. The flow splitter 232 is shown to be positioned at a vertical midpoint within the inlet system 210. However, the flow splitter 232 could be positioned higher (closer to a top surface) or lower (closer to a bottom surface).

The flow splitter 232 in FIG. 7 is shown with two bends. A first bend forms a first angle 251 of approximately 145°. The first bend is positioned near the filter 226. A second bend forms a second angle 252 of approximately 145°. The second bend is positioned within the reduction section 219. The first angle 251 and second angle 252 can be optimized using computational flow dynamics (“CFD”) tools to reduce flow separation and reduction in pressure drop in the inlet system 210. It is to be understood that the first bend and second bend are not limited to the angles 251, 252 in the shown example. Instead, the flow splitter 232 could be modified to include larger or smaller angles. In fact, in a further example, the flow splitter 232 may not include any bends and, instead, may include a straight portion extending horizontally or diagonally within the inlet system 210.

The flow splitter 232 could include a variety of different structures. For instance, the flow splitter 232 could include a strip of material, such as metal, that extends across the inlet system 210. It is to be understood, however, that the flow splitter 232 could include other materials, such as plastic, a combination of materials, etc. that extend across the inlet system 210. In another example, the flow splitter 232 can be substantially solid, such that air flow cannot flow through the flow splitter 232. In a further example, the flow splitter 232 could include a similar material as the screen 230, such that at least a portion of the air flow can pass through the flow splitter 232.

The flow splitter 232 can improve the thermal distortion within the inlet system 210 by increasing the mixing of the air flow. Specifically, the flow splitter 232 can assist in guiding more air flow from the upper half of the inlet system 210 through the inlet system 210. The gas turbine inlet (not shown) can draw air through the inlet system 210. However, a majority of air flow is from a bottom half of the inlet section 220. This is due, in part, to the reduction section and silencer rising to only approximately half the height of the inlet section 220. As such, with less air flow entering through a top half of the inlet section 220, warmer air can accumulate at the top half. The flow splitter 232 can assist in mixing the air by having more air drawn into the inlet section 220 from a top half of the inlet section 220. As such, the flow splitter 232 can assist in drawing air from both the top half and bottom half of the inlet section 220.

Though not shown in FIG. 7, the inlet system 210 can further include a duct section and an outlet. The duct section and the outlet can be substantially identical to the duct section and outlet shown and described above with respect to FIG. 2. The duct section can be positioned adjacent to and downstream from the silencer. The duct section can receive air flow from the silencer. The outlet can be positioned adjacent to and downstream from the duct section. The outlet can receive air flow from the duct section. As with the previous example, the outlet can be connected to a gas turbine inlet (not shown), such that the outlet defines a passageway through which the air flow can exit the inlet system and enter the gas turbine inlet.

The operation of the example inlet system 210 shown in FIG. 7 can now be described. Air can enter the inlet system 210 through the inlet section 220. The hoods 222 can at least partially reduce the amount of particles and/or precipitation that enters the inlet section 220. The temperature controlling section 224 can change the temperature of the air flow that passes through the temperature controlling section 224. Specifically, the temperature controlling section 224 can selectively heat or cool the air flow. After the air flows through the temperature controlling section 224, air near the bottom surface of the inlet system 210 can encounter the screen 230. Typically, colder air is disposed towards the bottom surface. As such, the screen 230 can simultaneously divert a portion of the air flow over the screen 230 and allow a portion of the air flow to flow through the screen 230.

In addition, flow splitter 232 can assist in drawing air equally from both the lower half and upper half of the inlet section 220. The flow splitter 232 can reduce the amount of warmer air that stagnates towards an upper portion of the inlet system 210. An inlet force by the gas turbine inlet (not shown) can draw air through the inlet system 210 such that more warm air enters and passes above the flow splitter 232. After the air passes through the flow splitter, the air can mix, such as in the duct section (not shown). Together, the combination of the screen 230 diverting cold air both through and around the screen, and the flow splitter 232 can mix the air flowing through the inlet system 210. This mixing can reduce the temperature difference between a maximum and minimum temperature within the air flow.

It is to be understood that the screen 230 and flow splitter 232 are not limited to the example shown in FIG. 7. For instance, in a further example, the screen 230 and flow splitter 232 could be included in either of the examples shown in FIGS. 2 and 3 or FIG. 6. As such, the screen 230 and/or the flow splitter 232 can be combined with an inlet system having a transition section 30 and/or a flow diverter 130, 132. As such, the example shown and described with respect to FIG. 7 can include some or all of the features from the examples shown and described with respect to FIGS. 2 and 3 and FIG. 6.

In general, it is to be appreciated that additional examples in accordance with the present invention could be provided via various combinations from the above described examples. For example, the transition section 30, one or more flow diverters 130, 132, one or more screens 230 and/or the flow splitter 232 can be provided in any combination within a single air inlet system.

The invention has been described with reference to the example embodiments described above. Modifications and alterations will occur to others upon a reading and understanding of this specification. Example embodiments incorporating one or more aspects of the invention are intended to include all such modifications and alterations insofar as they come within the scope of the appended claims.

What is claimed is:

1. An air inlet system for delivering a flow of air, the system including:
a temperature controlling section configured to alter temperature of the air flow, the temperature controlling section imparting a temperature variation distribution across different portions of the air flow; and
a transition section positioned downstream from the temperature controlling section, the transition section having surfaces oriented at an angle that is neither parallel not perpendicular with respect to a flow direction of the air flow entering the transition section to cause mixing of the different, temperature variant portions of the air flow and reduce the temperature variation distribution.

2. The inlet system of claim 1, including a filter positioned downstream from the temperature controlling section, the filter being configured to filter the air flow; and the transition section is positioned between the temperature controlling section and the filter.

3. The inlet system of claim 2, wherein the surfaces of the transition section extend upwardly relative to the temperature controlling section to the filter.

4. The inlet system of claim 3, wherein the surfaces of transition section extends at an angle ranging from 37° to 45° from flow direction of the air flow entering the transition section.

5. The inlet system of claim 3, wherein the transition section increases turbulence of the air flow.

6. The inlet system of claim 3, further including a silencer positioned downstream from the filter, wherein the silencer is configured to dampen noise.

7. The inlet system of claim 6, wherein the air flow flowing through the silencer has a temperature distribution of not more than approximately 12° F. between a maximum temperature and a minimum temperature.

8. The inlet system of claim 3, wherein the air flow flowing through an outlet of the inlet system has a temperature distribution of not more than approximately 5° F. between a maximum temperature and a minimum temperature.

9. The inlet system of claim 1, further including at least one flow diverter, wherein the at least one flow diverter is configured to divert the air flow around the at least one flow diverter.

10. The inlet system of claim 9, wherein the at least one flow diverter is positioned on a bottom surface of the inlet system.

11. The inlet system of claim 9, wherein the at least one flow diverter is positioned on an upper surface of the inlet system.

12. The inlet system of claim 1, further including a screen, wherein a first portion of the air flow is configured to be diverted around the screen, further wherein a second portion of the air flow is configured to flow through the screen.

13. The inlet system of claim 1, further including a flow splitter, wherein the flow splitter is configured to be positioned at a vertical midpoint within the inlet system, further wherein a first portion of the air flow is configured to flow under the flow splitter and a second portion of the air flow is configured to flow above the flow splitter.

14. An air inlet system for delivering a flow of air, the system including:
a temperature controlling section configured to alter temperature of the air flow, the temperature controlling section imparting a temperature variation distribution across different portions of the air flow; and
at least one flow diverter positioned downstream from the temperature controlling section, the at least one flow diverter extending transverse with respect to a flow direction of the air flow moving past the at least one flow diverter to divert the air flow around the at least one flow diverter to cause mixing of the different, temperature variant portions of the air flow and reduce the temperature variation distribution.

15. The inlet system of claim 14, wherein the at least one flow diverter includes a first flow diverter positioned at a bottom surface of the inlet system, further wherein the at least one flow diverter includes a second flow diverter positioned at an upper surface of the inlet system.

16. The inlet system of claim 15, wherein the first flow diverter is configured to divert colder air upwards over the first flow diverter, further wherein the second flow diverter is configured to divert warmer air downwards underneath the second flow diverter.

17. The inlet system of claim 14, further including a screen positioned downstream from the temperature controlling section, wherein at least a first portion of the air flow is diverted around the screen and at least a second portion of the air flow is configured to pass through the screen.

18. The inlet system of claim 14, wherein the at least one flow diverter includes a flow splitter, further wherein the flow splitter is configured to extend between opposing sides of the inlet system and at least some of the air flow is configured to flow under the flow splitter and the remaining air flow is configured to flow above the flow splitter.

19. An air inlet system for delivering a flow of air, the system including:
a temperature controlling section configured to alter temperature of the air flow, the temperature controlling section imparting a temperature variation distribution across different portions of the air flow; and
at least one screen positioned downstream from the temperature controlling section, the at least one screen extending transverse with respect to a flow direction of the air flow moving past the at least one screen, at least a first portion of the air flow moves through the screen to cause turbulence and cause mixing of the different, temperature variant portions of the air flow and reduce the temperature variation distribution; and
a flow diverter positioned downstream from the temperature controlling section and within the air flow to divert at least some of the air flow to a first side of the flow diverter and to divert at least some of the air flow to a second side of the flow diverter to cause turbulence and cause mixing of the different, temperature variant portions of the air flow and reduce the temperature variation distribution.

20. The inlet system of claim 19, wherein the flow diverter includes a flow splitter, further wherein the flow splitter includes a non-linear shape.
